(19) United States
(12) Patent Application Publication
(10) Pub. No.: US 2010/0293286 A1
(43) Pub. Date: Nov. 18, 2010

(54) Method and system for wireless real-time collection of multichannel digital audio

(75) Inventors: Seppo Nikkilä, Helsinki (FI); Tom Lindeman, Helsinki (FI)

Correspondence Address: Seppo Laine Oy;Joshua P. Wert, Itamerenkatu 3B, Helsinki, FI00180, FI

(73) Assignee: ANT - ADVANCED NETWORK TECHNOLOGIES OY, Helsinki (FI)

(21) Appl. No.: 12/677,307

(22) PCT Filed: Sep. 13, 2007
(86) PCT No.: PCT/FI07/50488

§ 371 Date: Jun. 24, 2010

(51) Int. Cl. G06F 15/16

(52) U.S. Cl. 709/231; 709/233

(57) ABSTRACT

In this application is described a method and a system for collecting streaming multi channel digital isochronous data from multiple independent digital signal sources. The method is used for collecting streaming multi channel digital isochronous data, e.g. audio data, in a standard wireless local area network transmission system where bandwidth is reserved for both contention-based traffic and contention free traffic and the audio data (10) formed by samples (9) is organized in audio frames (174) and sent to receivers (6) using multicasting, within consecutive beacon intervals (137). In accordance with the invention the contention free traffic (138) of the beacon interval (137) is adjusted to an optimum value, and the length of the beacon interval (137) is adjusted such that a required amount of audio data (9) can be sent to the receivers (6) with minimum system delay.

The invention relates to a method according to the preamble of claim 1 for wireless real-time signal collection from several independent sources for mainly audio purposes.

The invention relates also to a system according to the preamble of claim 6 for wireless signal collection from several independent sources for mainly audio purposes.

The invention relates to an error control method and system and a synchronization method and system for the said purposes.

The object of this invention is typically a system with the associated apparatus and method for the isochronous, electromagnetic disturbance resistant, wireless transfer of highest studio-quality multi-channel digital audio signals from several independent but synchronized sources to a central station. This same method can also be used as the basis of the high-speed transmission of other digital information with the same kind of real-time and bandwidth requirements such as synchronized digital measurements from several independent sources.

### INTRODUCTION

With the currently known technique, the studio-quality multi-channel digital audio signal from a set of independent signal sources such as microphones is first transferred to the multi-channel digital mixer with the balanced per-channel electrical cables. The analog-to-digital conversion is performed in the mixer and the channels are finally recorded to a digital storage device after the required balancing and mixing operations have been applied. Also, a transmission method with special purpose radio links is known. The physical analog transmission path injects several degrading effect such as noise, interference, distortion, group delays, amplitude and phase errors to the quality of the original signal. The cabling is often clumsy and can be messy looking especially in concert occasions. With careful design and balancing of cables and their wiring layout, these effects can be limited to some extent but seldom completely eliminated. The number and bulkiness of the cables, the need for careful design and tedious installation work increase the costs as well as required skills and time. Cables and their electromechanical connectors are also prone to mechanical failures, which are hard to find and fix. These problems are especially harmful in public performances when the performers and often even the audience move among the cables. Under these conditions, there can be a real hazard of harm and injury with the cabling. During artistic tours, the audio equipment is installed and uninstalled frequently to and from varying environments, which multiplies these problems, efforts, and costs.

With the use of modern capacitive microphones, having integrated and optimised preamplifiers within them, the analog signals can be of lower power level and also the more noise and interference resistant differential signalling can be employed. The generation of multi-channel differential signals requires, however, rather expensive high-quality analog electronics plus costly differential cabling and connectors independently of what type of microphones are used.

The currently available wireless audio microphone systems are non-standard radio or infrared solutions typically using lossy audio compression methods thus resulting compromised performance. They are therefore mainly used for supportive purposes such as public address voice transmission.

The aim of this invention is to solve problems relating to the isochronous real-time collection of the highest studio-quality streaming digital audio signals associated with the techniques described above by constructing a novel, international standards compliant wireless local area network (WLAN) based data communication system, transmitters, receiver plus the necessary firmware and software for the efficient restricted area collection of digital audio signals and the testing, configuration, management and control of such systems.

The invention is based on the idea that the digital information is transferred using special speeded-up sequential unicast from the different transmitter stations to the central collecting station in the studio-quality digital format with electro-magnetic radio waves without dedicated signal cables using typically internationally standardized and high-volume produced wireless local area networking (WLAN) components. The analog signal is converted to the digital form directly at the signal source and fed locally to the associated WLAN transmitter. This guarantees the ultimate sound quality at the microphone transmitter. Because of the application of the mass-produced WLAN technique and its commercial components plus the very small number of additional standard integrated circuits, the cost of the development work and the actual system components can be kept very reasonable. This part of the system is typically powered by a rechargeable battery pack, which additionally helps in achieving noise free source signals.

The method introduced here replaces the wired lines with the standard commercial wireless local area network technology as specified in the IEEE 802.11 series of standards. The special characteristics required for the uncompressed real-time transfer of multi-channel studio-quality audio signals have been implemented by the innovative choice of WLAN system coordination functions, communication modes, and control parameters together with a special upper layer firmware implementing the speeded-up sequential unicast.

In accordance with a preferred embodiment of the invention the audio data formed by samples is organized in audio frames and sent from the individual microphone stations to the receiver station within consecutive beacon intervals, using coordinated, speeded-up unicast messaging. According to the WLAN standards, two co-existing transmission services are possible. The usual mode, widely used in commercial data communication products, is called the contention-based service. The other mode, used seldom, but accurately specified in the IEEE 802.11 standard, is called the contention-free service, and it is the basis for this invention. Special beacon frames are used to control the switching between these two modes of operation. The length of the beacon interval is a programmable parameter and it is adjusted with this invention so that an optimum amount of isochronous audio signal data can be sent to the receiver, with a minimum of system delay. This optimal amount is in one preferred embodiment of the invention for the required amount of isochronous audio signal data for high quality audio broadcasting and recording.

In accordance with another preferred embodiment of the invention, an error control system optimised for isochronous digital audio transfer either minimizing the need or totally eliminating the need for retransmissions is used, where the received signal is correlated with other channels, is used for error correction purposes.

In accordance with a third preferred embodiment of the invention, the transmitters and their signal sampling are synchronized in a coordinated unicast system with the help of an end-of-frame interrupt, generated by the control frame terminating each beacon interval, at the exactly same instance within each beacon interval. This synchronization is further utilized to trigger the accurate coherent sampling of the audio signals of the independent sources and as the reference instance for the individual timers of the signal source transmitter timers that trigger the coordinated unicast transmission at the proper instance so that each transmitter is active at the right period of time without interfering with others.

In accordance with a fourth preferred embodiment of the invention, the transmission order and sequential timing of the transmitters are synchronized in a coordinated speeded-up burst unicast system with the help of an end-of-frame interrupt, generated by the control frame terminating each beacon interval, at the exactly same instance within each beacon interval and accurate timers in transmitters triggering the actual frame transmission at the right instance of time. This speeded-up arrangement guarantees the best possible usage of the WLAN bandwidth from a set of independent transmitters to a single receiver.

More specifically, the method according to the invention is characterized by what is stated in the characterizing part of claim 1.

Further, the system according to the invention is characterized by what is stated in the characterizing part of claim 6.

With the help of the invention significant benefits may be obtained.

With the coordinated per-signal-source transmission of the studio-quality digital audio, all the error factors associated to the traditional signal path can be avoided. Performing the digital-to-analog conversion immediately at the signal source itself maximizes the sound quality by localizing the propagation path of the analog signal on the fixed and optimized converter circuitry in accordance with one embodiment of the invention.

The signal cables, their connectors and differential signal transmitter/receivers and related material and installation work can be completely avoided. This eliminates all the cost, failure, and installation problems associated with them. As mass produced standard WLAN technique is the basis of the invention, its production cost can be made very low in accordance with one embodiment of the invention.

As the coordinated, speeded-up burst unicast transmission mode and frequent multicast synchronization are utilized, the sampling synchronization and the inter-channel phase errors can be effectively eliminated in accordance with one embodiment of the invention.

As optimized transmission frame sizes are used, the system level delay as well as the buffering requirements can be minimized to an insignificant level in accordance with one embodiment of the invention. The proper varying of the frame size further guarantees the smooth, even flow of the data stream.

With the help of the error control method in accordance with one embodiment of the invention a simple and fast best-effort audio error correction scheme can be obtained.

In the following, the invention will be described in more detail with reference to the exemplifying embodiments illustrated in the attached drawings in which

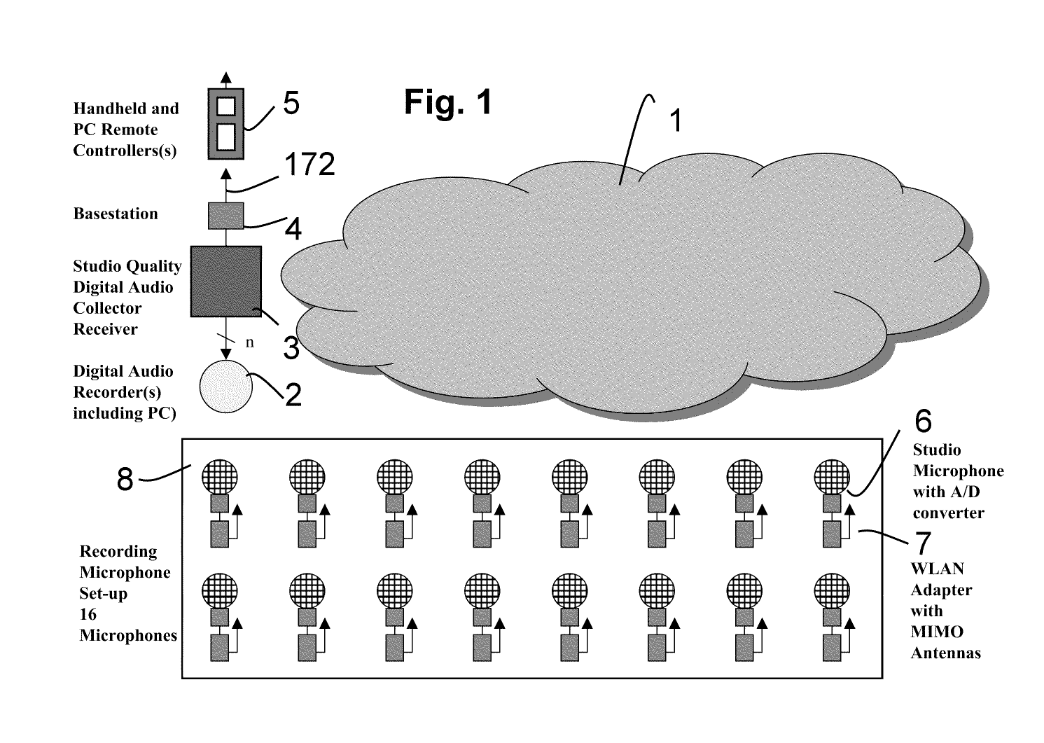

FIG. 1 shows as a block diagram a general system configuration of the invention.

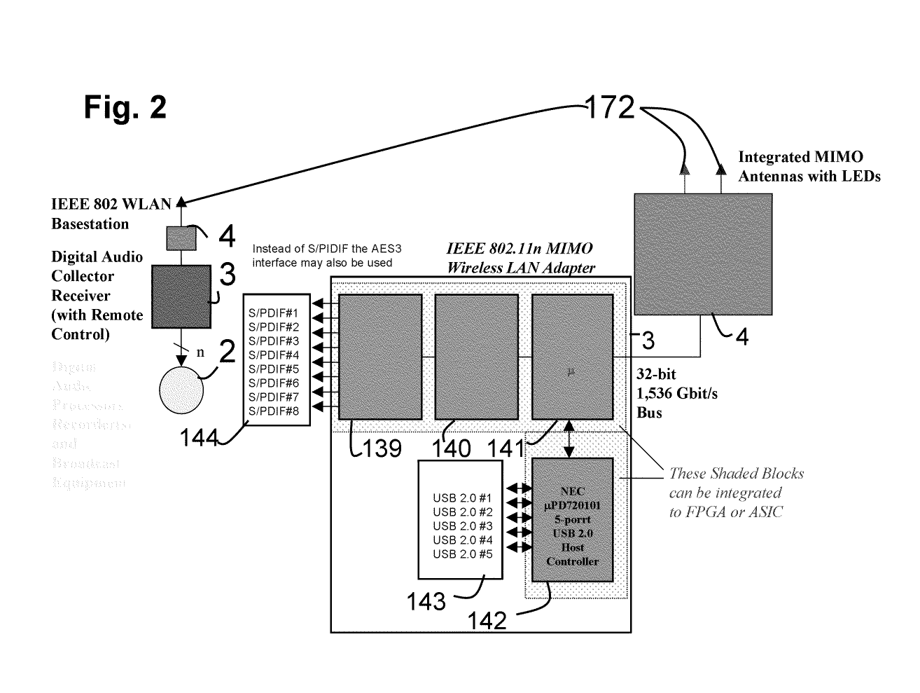

FIG. 2 shows as a block diagram an example transmitter station in accordance with the invention.

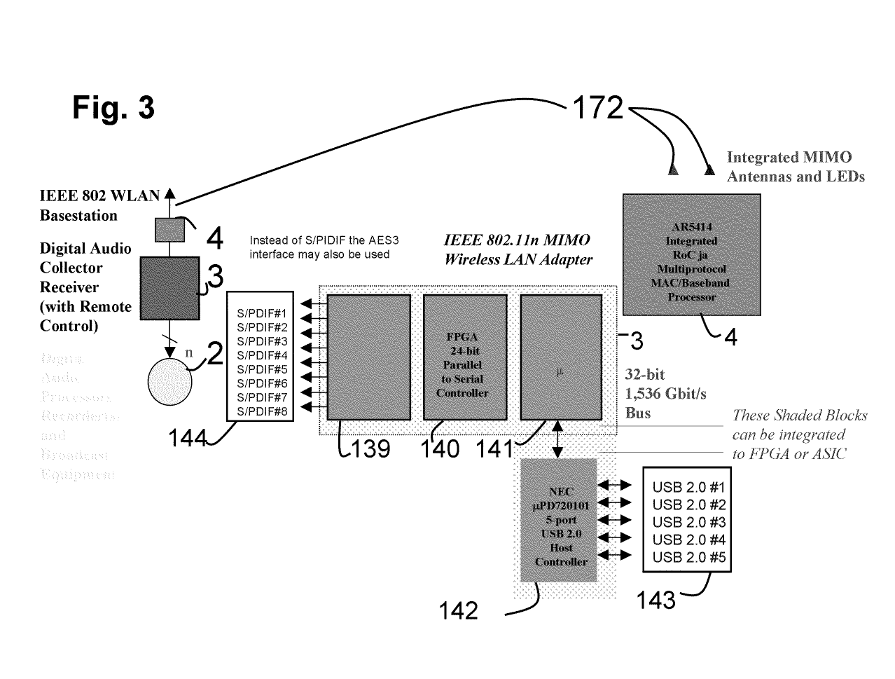

FIG. 3 shows as a block diagram another example transmitter station in accordance with the invention.

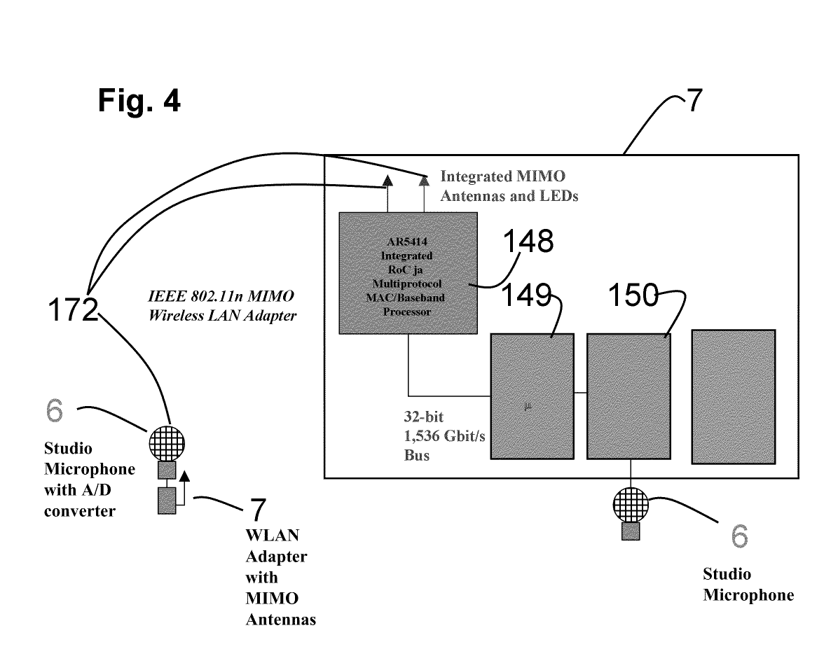

FIG. 4 shows as a block diagram an example receiver in accordance with the invention.

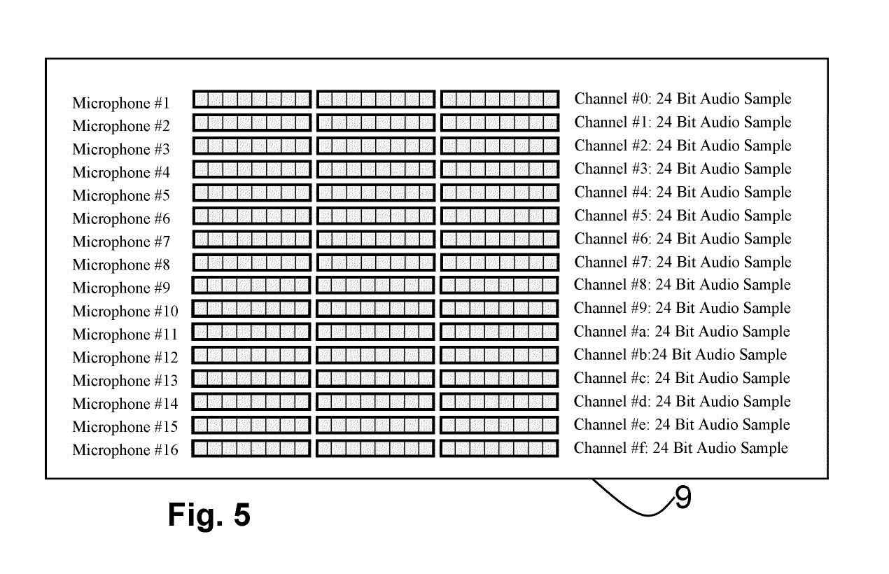

FIG. 5 shows the audio data structure representing one multi channel audio sample in accordance with the invention.

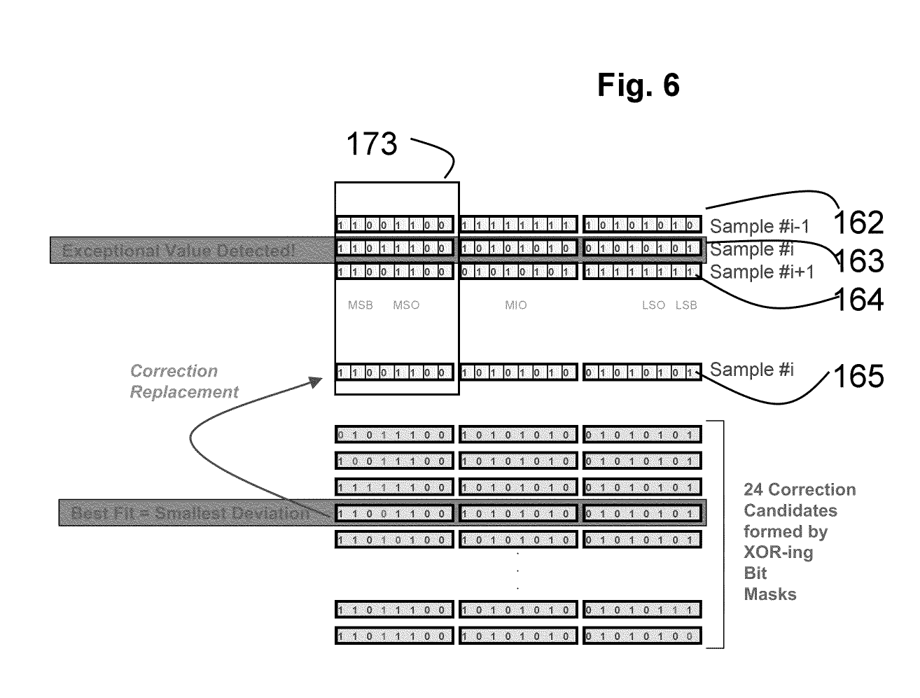

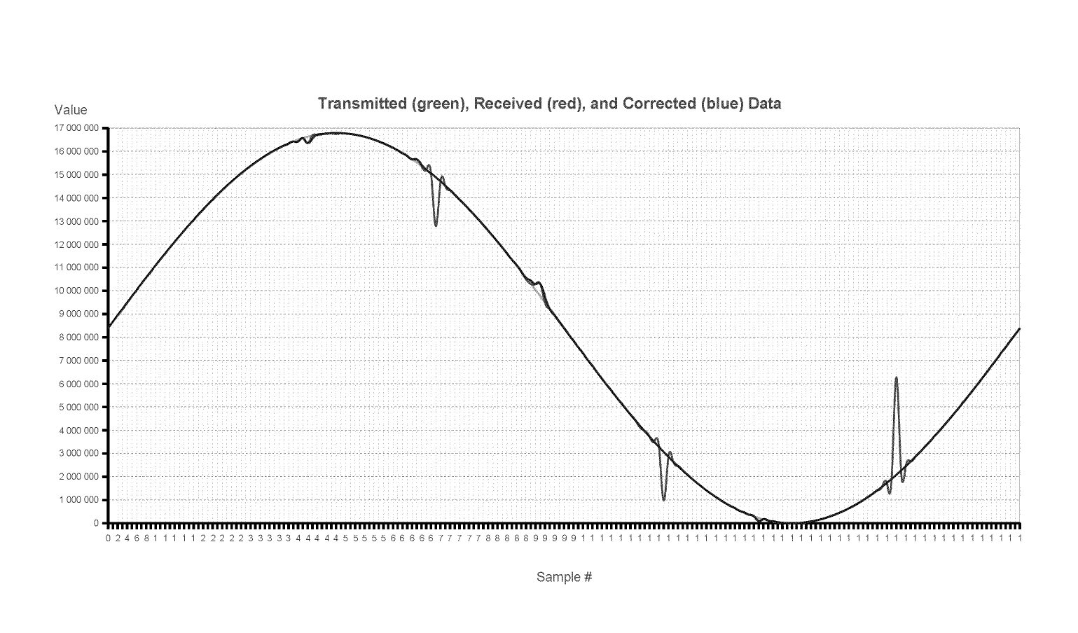

FIG. 6 shows a data structure representing one audio sample 16-tuple with the appended error control blocks in accordance with the invention.

FIG. 7 shows with the help of the data structure of FIG. 6, the error correction principle in accordance with the invention.

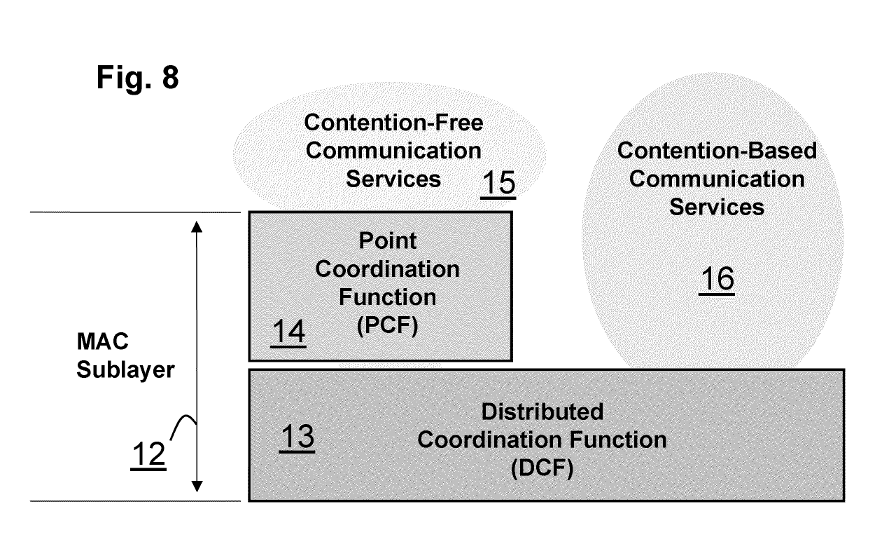

FIG. 8 shows as a block diagram the Medium Access Control (MAC) architecture, which can be used with the invention.

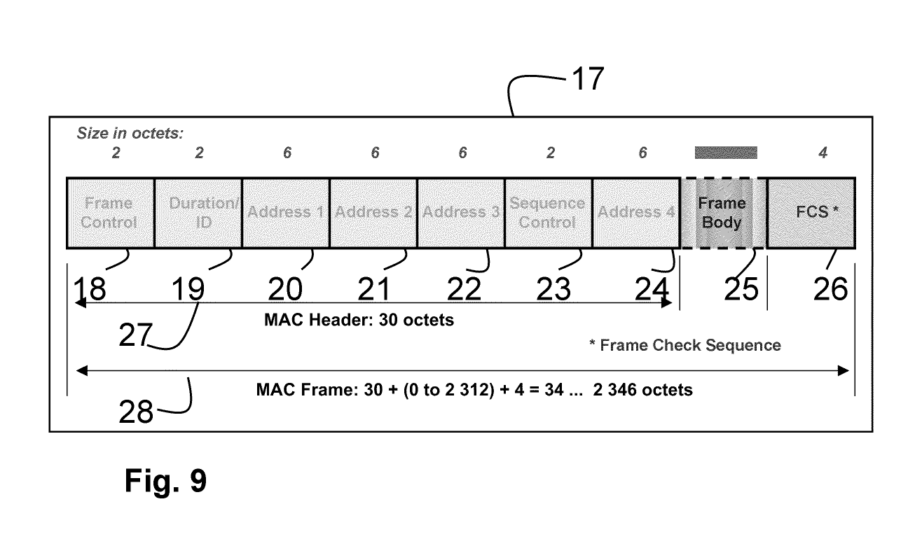

FIG. 9 shows as a data structure the general MAC frame structure, which can be used with the invention.

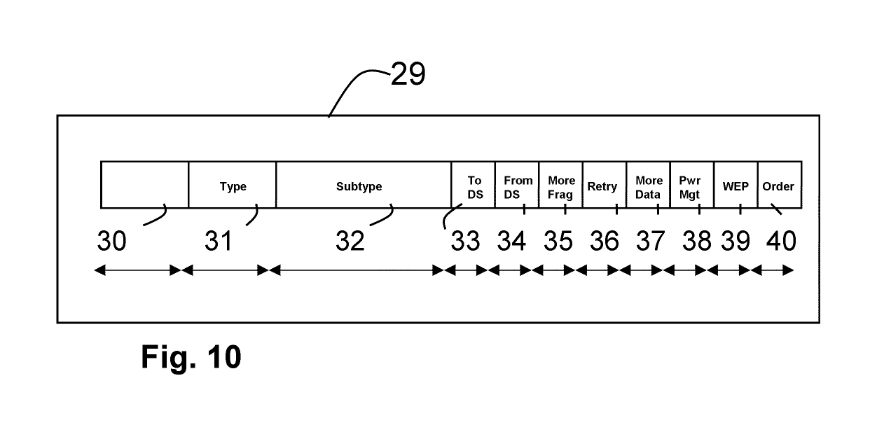

FIG. 10 shows as a data structure the WLAN frame control field, which can be used with the invention.

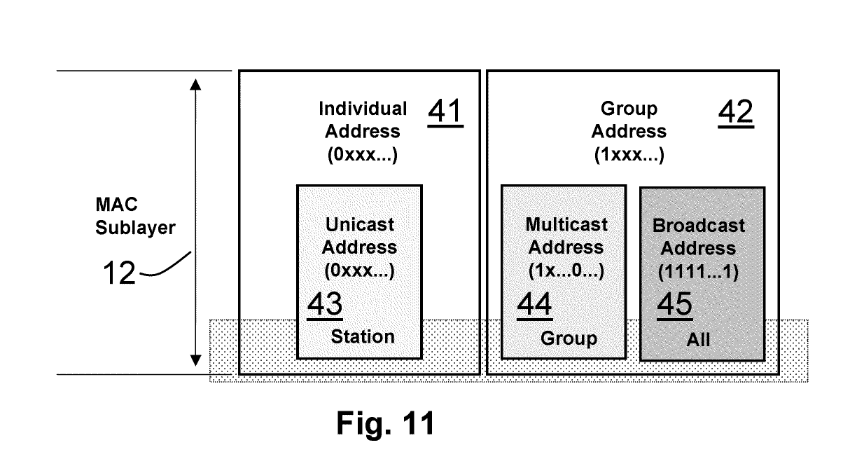

FIG. 11 shows as a block diagram the possible medium access control (MAC) addresses, the multicast version of which can be used with the invention.

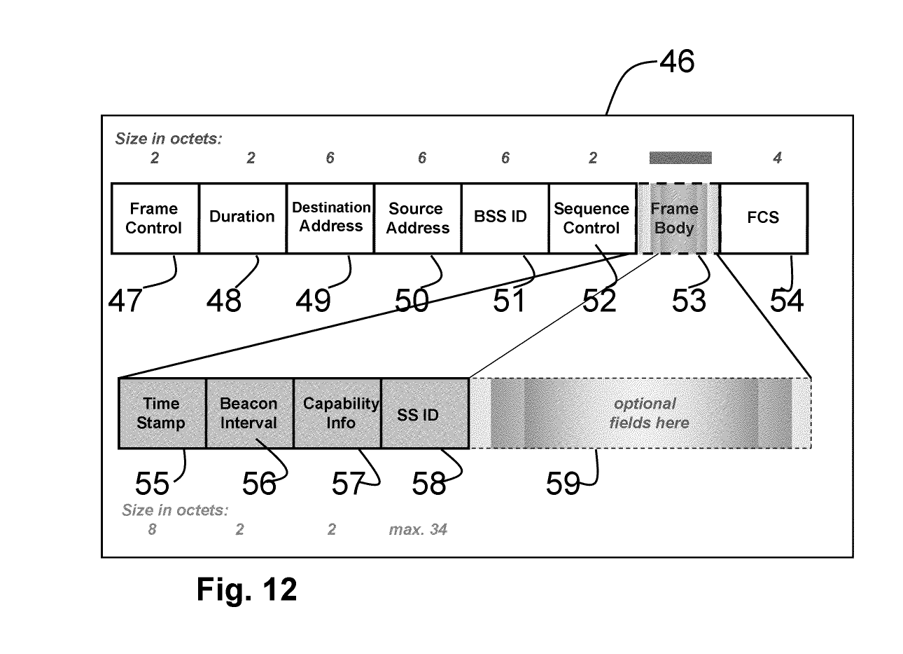

FIG. 12 shows as a data structure the generic beacon frame, which can be used with the invention.

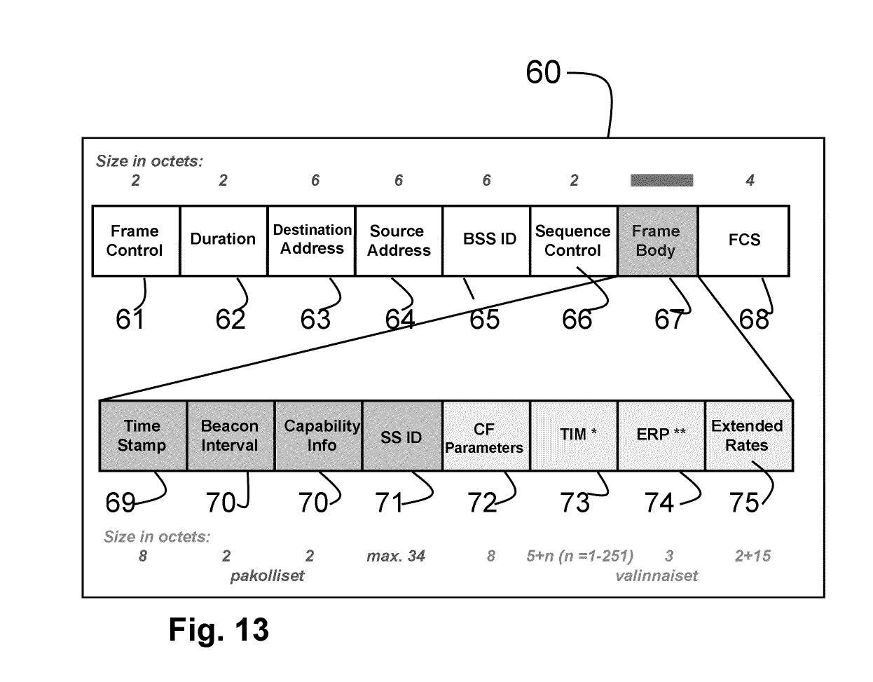

FIG. 13 shows as a data structure a beacon frame in accordance with the invention.

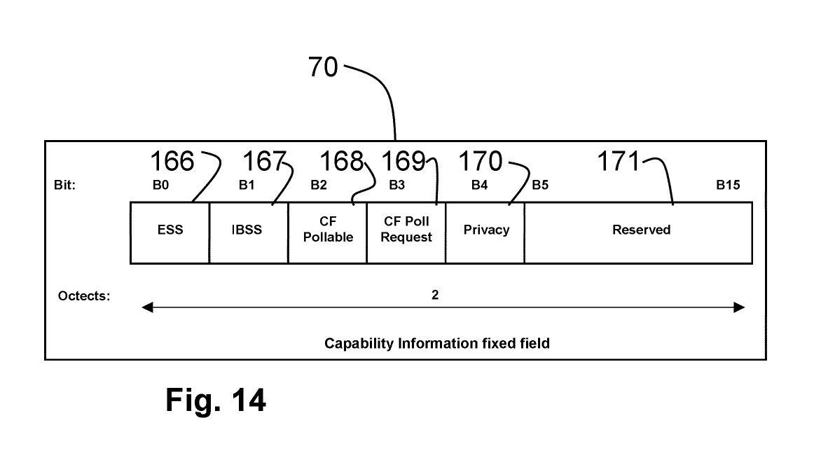

FIG. 14 shows as a data structure a capability information field, which can be used with the invention.

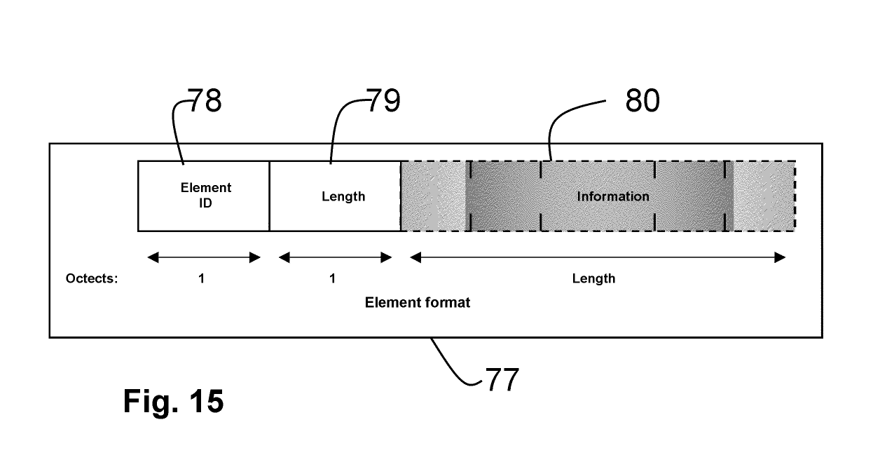

FIG. 15 shows as a data structure information elements, which can be used with the invention.

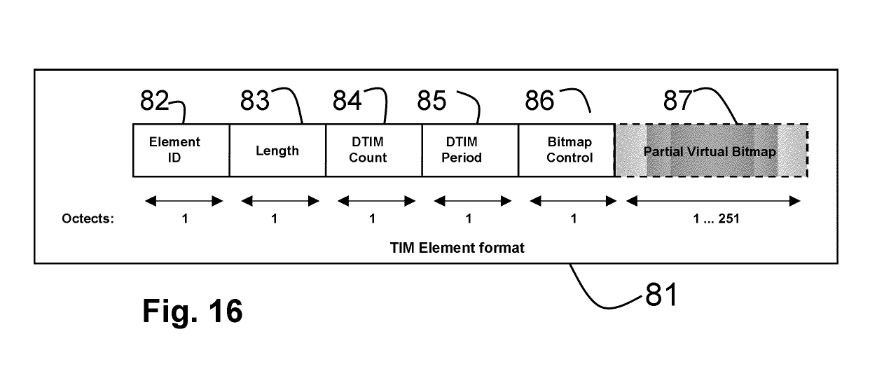

FIG. 16 shows as a data structure the Traffic Indication Map (TIM) element format, which can be used with the invention.

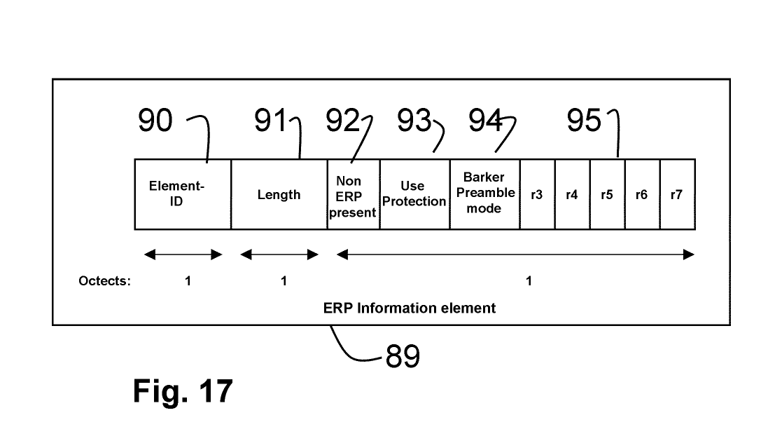

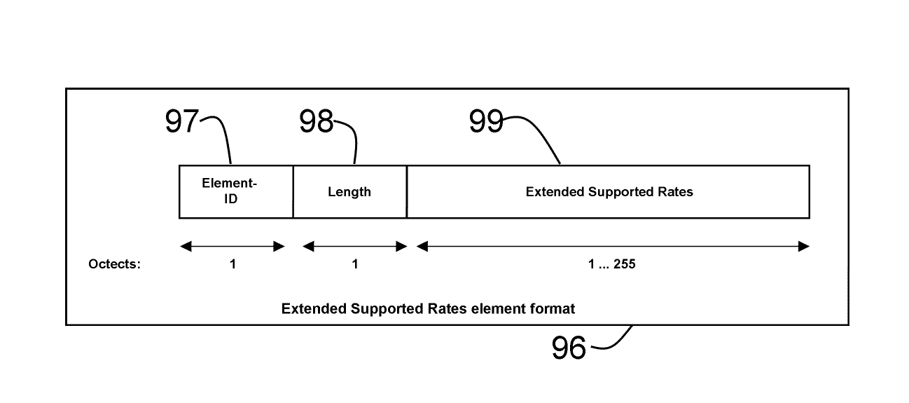

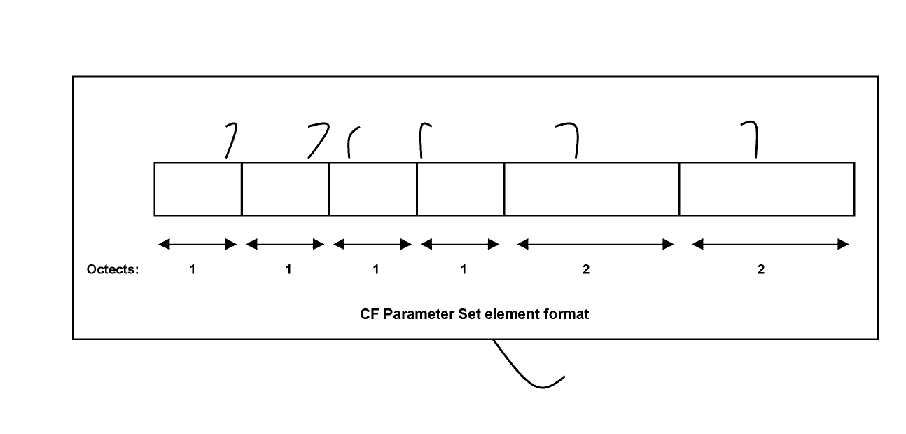

FIG. 17 shows as a data structure the Extended Rate PHY (ERP) information element, which can be used with the invention.

FIG. 18 shows as a data structure an extended supported rates element, which can be used with the invention.

FIG. 19 shows as a data structure the Contention-Free (CF) parameter set element, which can be used with the invention.

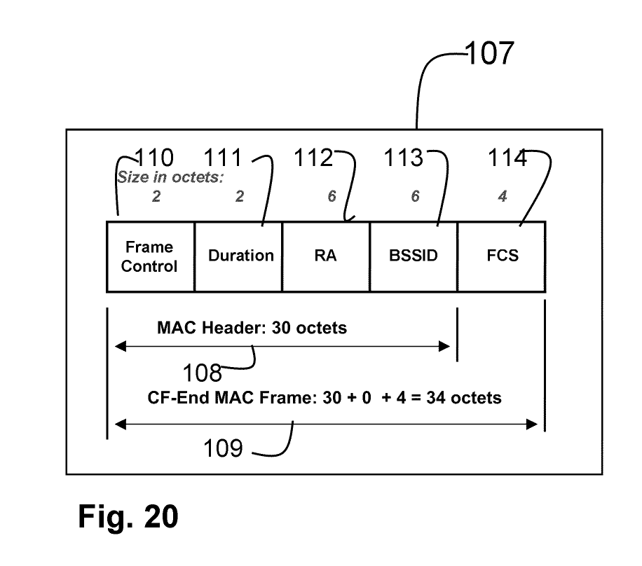

FIG. 20 shows as a data structure a CF-End Frame, which can be used with the invention.

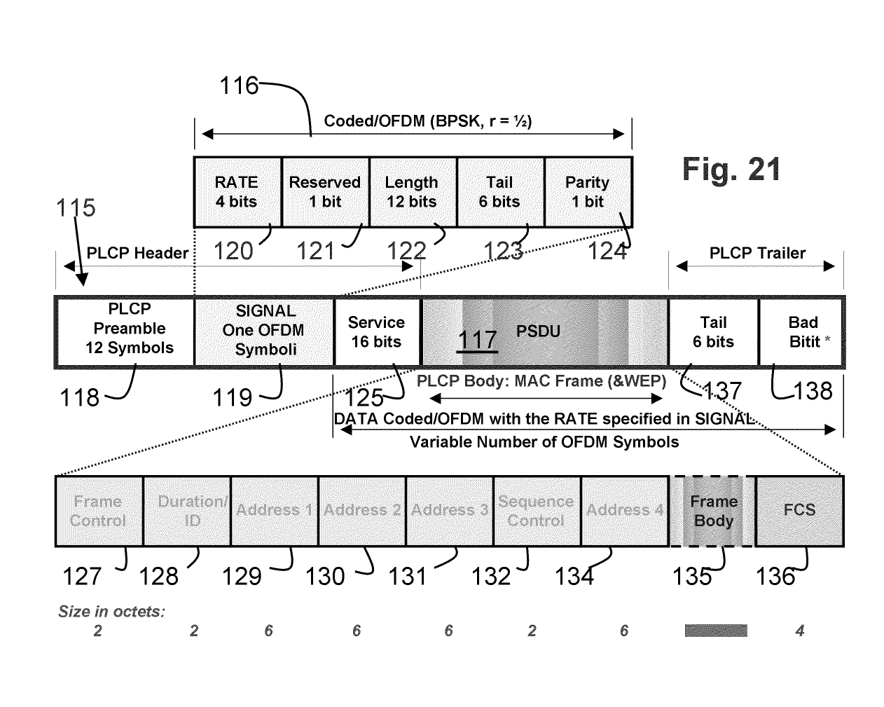

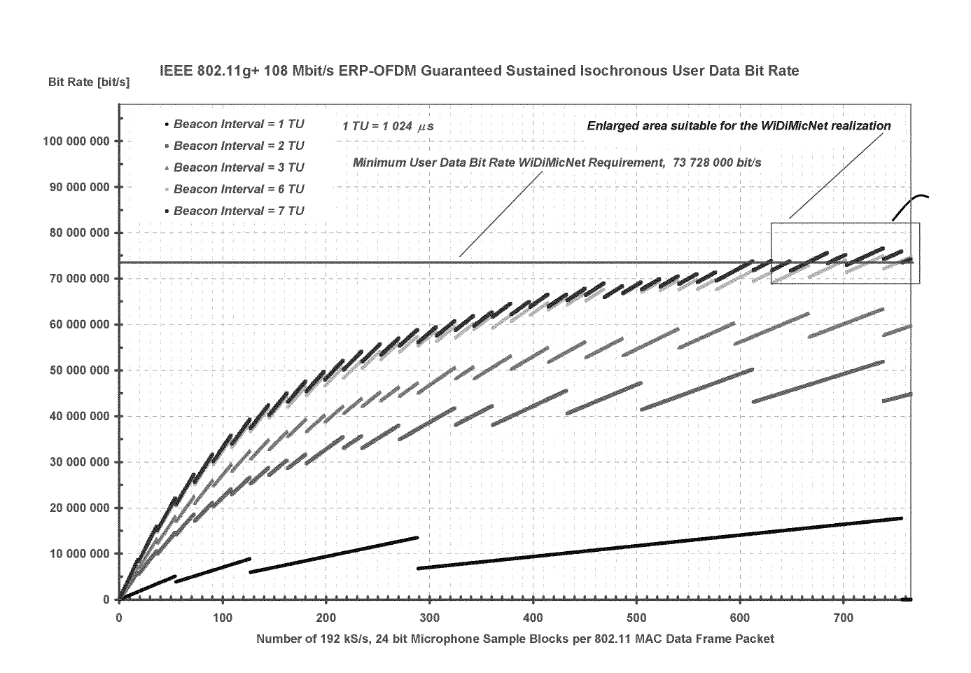

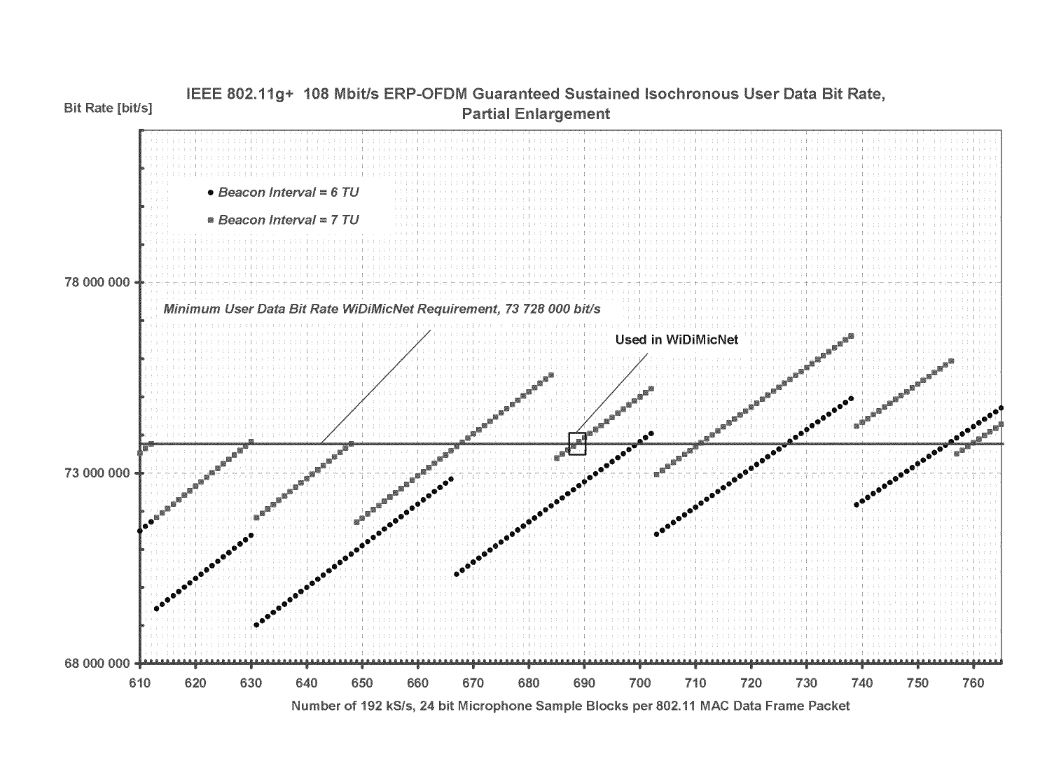

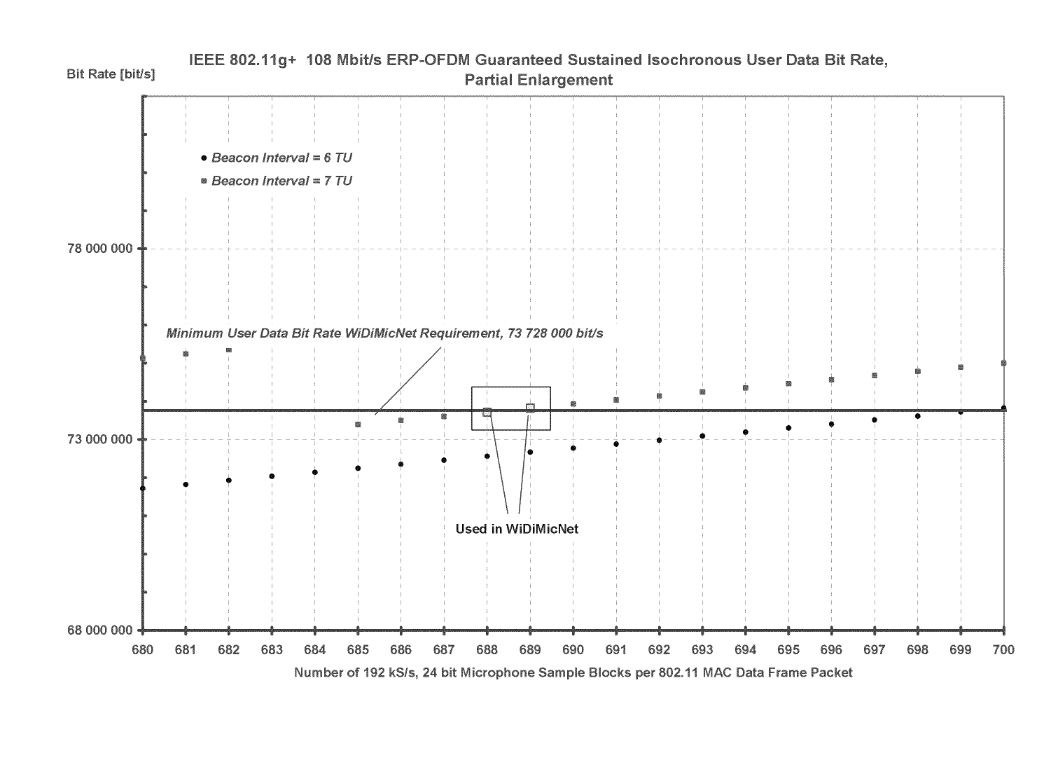

FIG. 21 shows as a data structure an ERP-OFDM PHY frame structure, which can be used with the invention.

FIG. 22 shows as a graph the bandwidth requirement for the invention.

FIG. 22a shows a detail of FIG. 22.

FIG. 22b shows a detail of FIG. 22a.

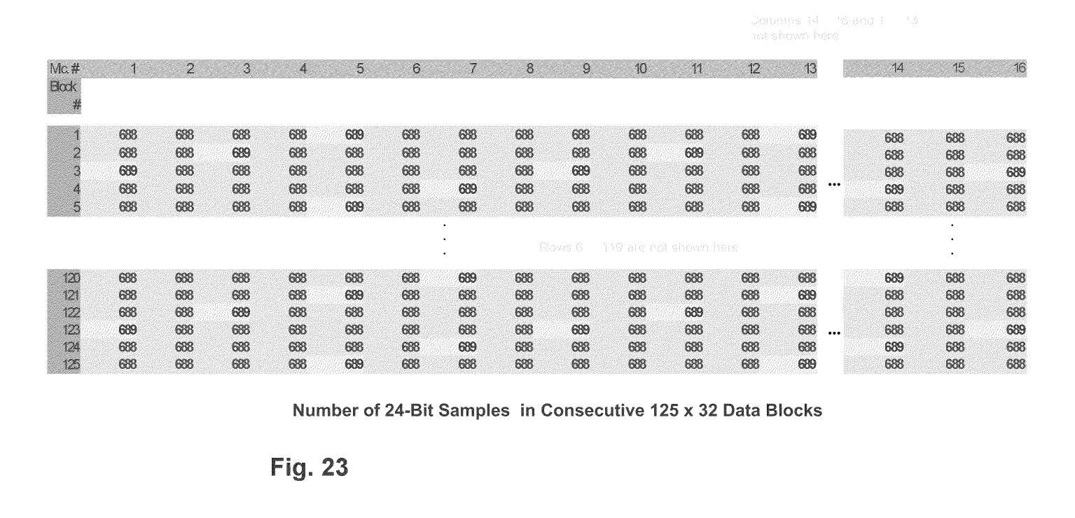

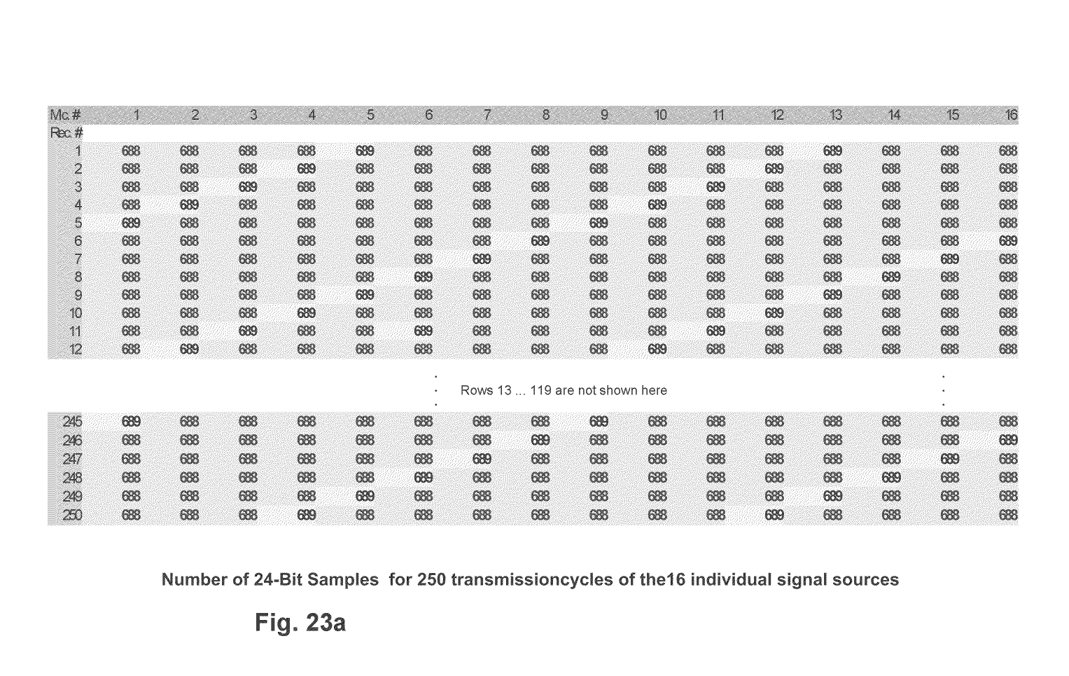

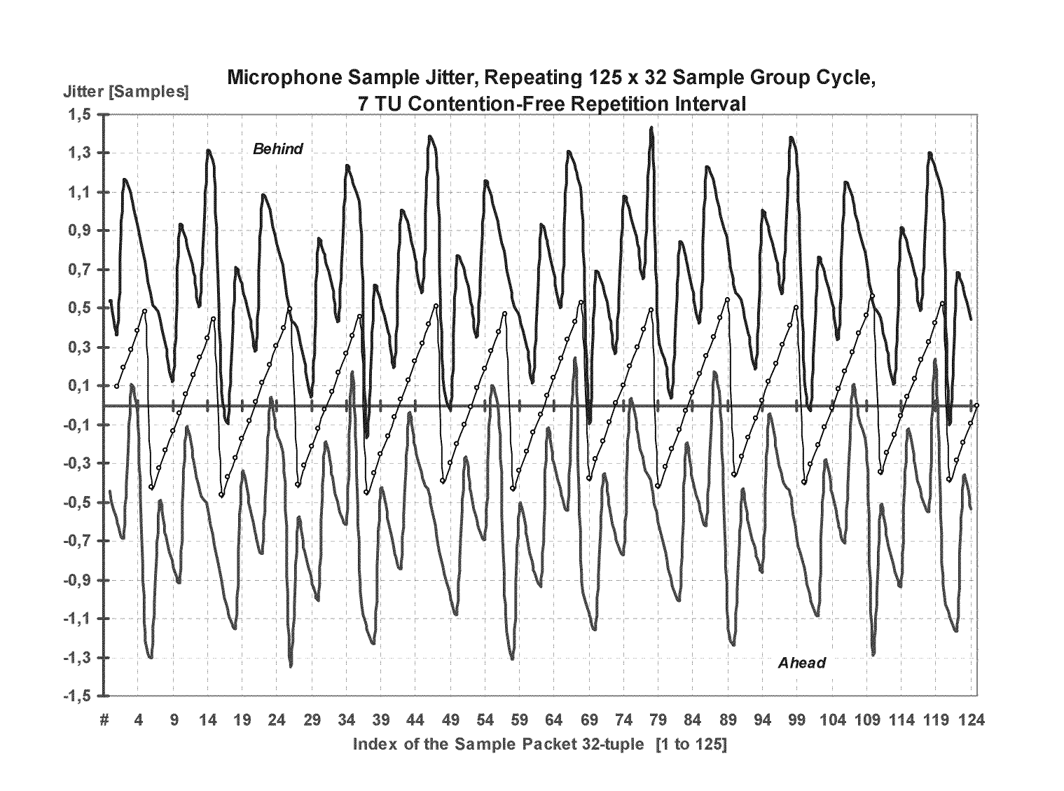

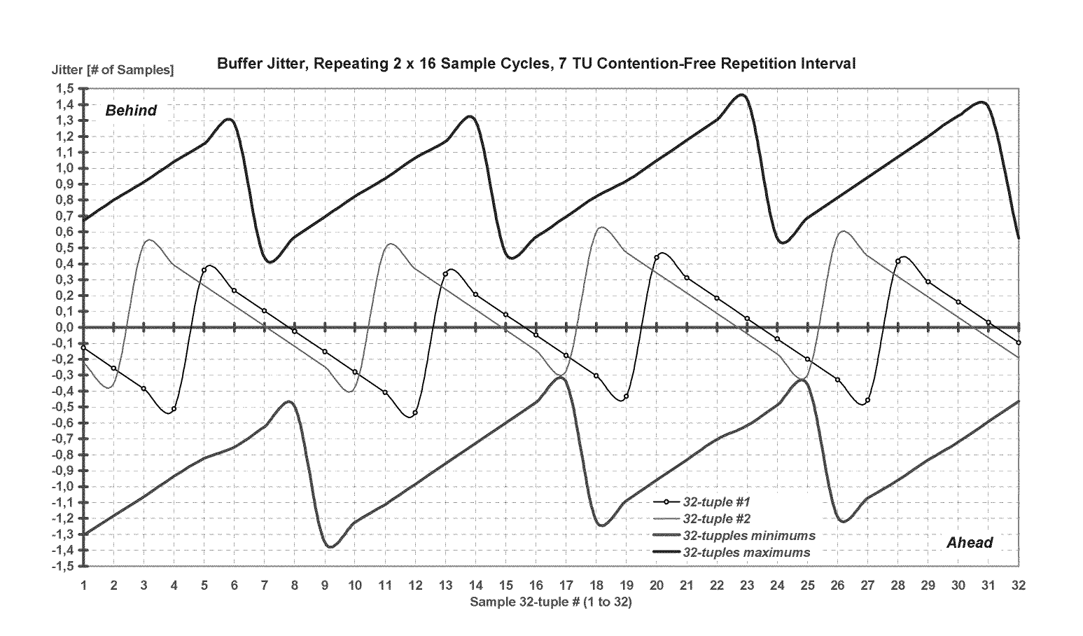

FIG. 23 shows as a table the number of 16×24-bit sample records in consecutive data blocks in accordance with the invention, relating to proper sequencing of digital audio for transmission.

FIG. 23b shows as a table the number of 24-Bit samples for 250 transmission cycles of the 16 individual signal sources.

FIG. 24 shows as a graph the jitter behaviour in accordance with the invention.

FIG. 24a shows as an enlarged graph the jitter behaviour in accordance with the invention and FIG. 24.

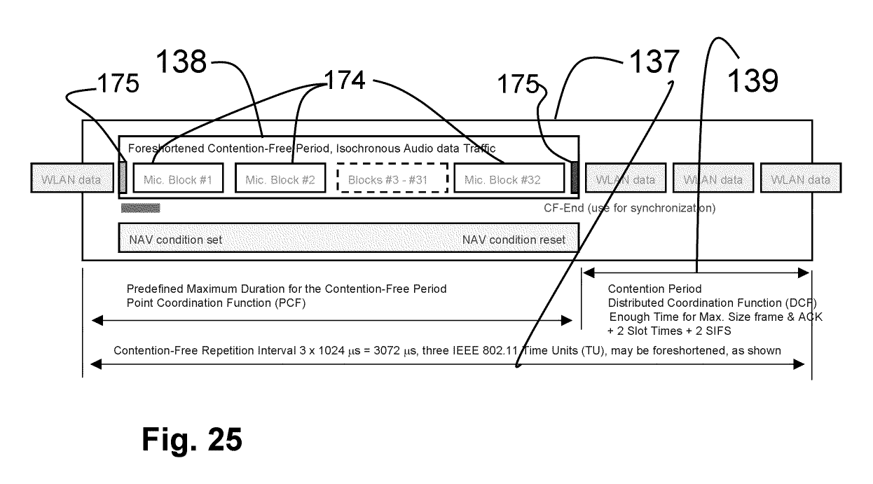

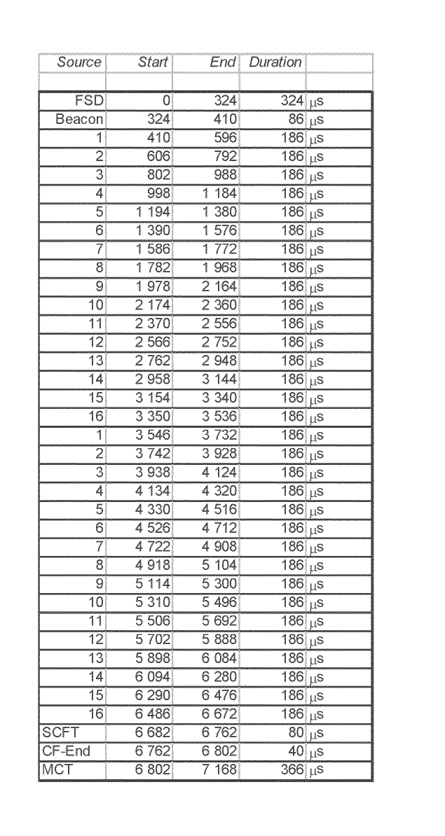

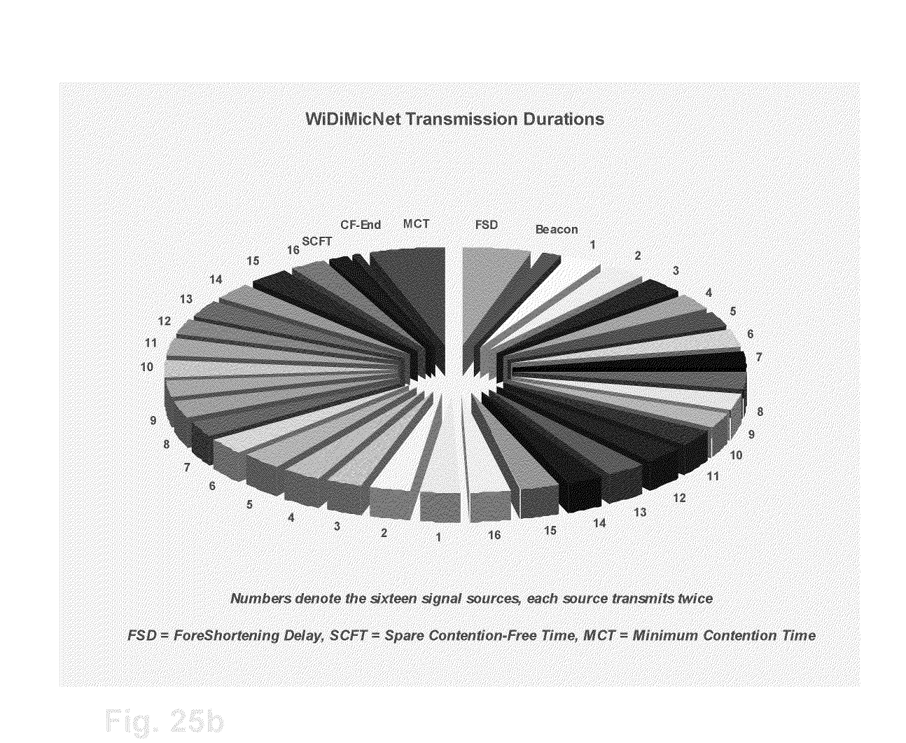

FIG. 25 shows as a block diagram a general data structure in accordance with the invention relating to the worst-case transmission timing.

FIG. 25a shows as a table the timing of the beacon signal.

FIG. 25b shows as a graph the transmission durations of the invention.

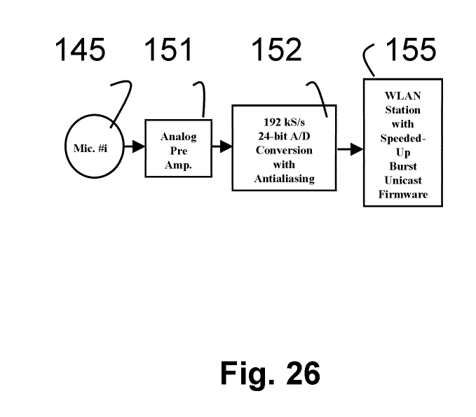

FIG. 26 shows as a flow chart audio input processing in accordance with the invention.

In this document, the following terms will be used in connection with the inventions.
1 WLAN, Wireless Local Area Network
2 mixer or recorder
3 collector receiver
4 Base station
5 Remote controller
6 audio source
7 transmitter
8 signal source subsystem
9 audio data format/sample
10 transmission level audio data format
11 error correction code
12 MAC sublayer, MAC=Medium Access Control
13 Distributed coordination function
14 Point coordination function
15 Contention-free communication services
16 Contention-based communication services
17 General MAC frame structure
18 Frame control
19 Duration/ID
20 Address 1
21 Address 2
22 Address 3
23 Sequence Control
24 Address 4
25 Frame body
26 FCS, Frame Control Sequence
27 MAC Header
28 MAC Frame
29 WLAN frame control field
30 Protocol version
31 type
32 Subtype
33 To DS, DS=Distribution System
34 From DS
35 More Frag
36 Retry
37 More data
38 Pwr Mgt
39 WEP, Wired Equivalent Privacy
40 Order
41 Individual Address
42 Group Address
43 Unicast Address
44 Multicast address
45 Broadcast address
46 Generic Beacon Frame
47 Frame control
48 Duration
49 Destination address
50 Source address
51 BSS ID
52 Sequence control
53 Frame body
54 FCS
55 Time stamp
56 Beacon interval
57 Capability info
58 SSID, Service Set IDentity
59 Optional fields
60 Beacon frame as used in this invention
61 Frame control
62 Duration
63 Destination address
64 Source address
65 BSSID, Basic Service Set IDentity
66 Sequence control
67 Frame body
68 FCS
69 Time stamp
70 Beacon interval
71 Capability info
72 SSID
73 CF parameter set
74 TIM, Traffic Indication Map
75 ERP, Extended Rate PHY
76 Extended rates
77 Element format
78 Element ID
79 Length
80 Information
81 TIM element
82 Element ID
83 Length
84 DTIM Count, DTIM=Delivery Traffic Indication Map
85 DTIM Period
86 Bitmap Control
87 Partial Virtual Bitmap
89 ERP information element
90 Element ID
91 Length
92 Non ERP-present
93 Use protection
94 Barker Preamble mode
95 r3-r7
96 Extended Supported Rates element format
97 Element ID
98 Length
99 Extended Supported rates
100 CF Parameter Set element format, CF=Contention-Free
101 Element ID
102 Length
103 CFP Count
104 CFP, Contention-Free Period
105 CFP Max Duration
106 CFP DurRemaining
107 CF-End frame
108 MAC-header
109 CF-end MAC Frame
110 frame control
111 Duration
112 RA, Receiver Address
113 BSSID
114 FCS
115 ERP-OFDM PHY Frame structure, OFDM=Orthogonal Frequency Division Multiplexing
116 Coded/OFDM
117 PSDU, Protocol Service Data Unit
118 PLCP Preamble
119 SIGNAL
120 Rate
121 Reserved
122 LENGTH
123 Tail
124 Parity
125 Service
127 Frame control
128 Duratrion/ID
129 Address 1
130 Address 2
131 Address 3
132 Sequence Control
133 Address 4
134 Frame body
135 FCS
136 Area of interest
137 WLAN Repetation period/Beacon interval (N*TU)
138 Foreshortened contention-free Period
139 Multiplexer and receiver
140 Serial to parallel converter
141 Buffer
142 USB host controller, USB=Universal Serial Bus
143 USB inputs
144 S/PDIF-inputs, S/PDIF=Sony/Philips Digital InterFace
145 Analog inputs
146 Analog buffers and multiplexers
147 A/D-converters, A/D=Analogue-to-Digital
148 MAC/baseband Processor
149 Microcontroller
150 D/A-converter and filter, D/A=Digital-to-Analogue
151 Select analog input
152 A/D-conversion
153 Select Digital input
154 24-bit reformatting
155 Select audio input
156 Number of channels 8
157 No
158 Yes
159 generate FEC and write to buffer, FEC=Forward Error Correction
160 Calculate missing channels
161 generate FEC and write to buffer
162 sample i−1
163 sample i
164 sample i+1
165 corrected sample i
166 ESS, Extended Service Set
167 IBSS
168 CF Pollable
169 CF Poll Request
170 Privacy
171 Reserved
172 Antenna
173 Most significant bits
174 Audio MAC frame
175 Control MAC frame

### System

In accordance with FIG. 1, the system comprises one or several audio signal sources 6, which may be either digital or an analog sources. In FIG. 1 these are represented by studio microphones. The sources 6 are digitised, if necessary, and fed to the WLAN adapter and transmitter 7, which includes an antenna arrangement for robust wireless transmission to the collector receiver 3 and from there to the sound consoles, mixers, recorder(s) 2 or to broadcast subsystems. The receiver 3 and the base station 4 are typically controlled by a remote controller 5 or a computer. The signal from the signal station 7 is sent via a WLAN based network 1 using a sequence of isochronous, coordinated unicast messages to the receivers 4 from the signal source subsystem 8, consisting, for example, of several microphones 6. In other words the audio signal from sources 6 is transformed into digital data by elements 7 and transferred to the collector receiver as standard WLAN digital data.

### Transmitter Base Station

FIG. 2 shows a simple example version of the collector receiver base station 4 and the audio storage and broadcasting equipment 2. The collector receiver base station 4 is typically a 108 Mbit/s extended IEEE 802.11g WLAN MIMO Access Point station, which receives a specified number of digital audio signals from the source transmitters. 108 Mbit/s is practically the lowest possible standard bit rate for the system of this invention. In the future, higher WLAN transmission speeds are expected and can be used to increase the number of signal sources in proportion to the increased transmission speed. They will also make it possible to improve the error correction methods using selective retransmissions. The received digital analog signals from the source transmitters it is converted to S/PIDIF or AES3 bit streams for processing, recording, and broadcasting.

Within the collector receiver station 3 there is a 48 KB memory ring buffer 141 or FIFO buffer for the intermediate storing of the incoming data. After initialization the collector receiver station 3 uses the contention mode traffic to initialise the signal sources. Each source is identified based on its unique MAC address and is assigned a sequence number ranging from 1 up to a maximum of 16. This sequence number is used as the basis of the coordinated sequential speeded-up unicast transmission described later. To start the collection the collector station changes its operation to the contention-free mode setting the beacon interval to 6 TUs and sending to the source stations a command to start the signal sampling from the synchronizing end-of-frame interrupt of the next CF-End control frame. From this point the coordination of the transmission is allocated to the cooperating signal source stations as described later. The WLAN part of the collector receiver station (and the source transmitters) conforms to the IEEE 802.11g standard with the range and transmission rate extensions introduced by Atheros Inc. and Airgo Inc. A MIMO antenna arrangement 172 is typically also used. The nominal bit rate is 108 Mbit/s. These implementations of the extended IEEE 802.11g WLANs also contain a powerful transmission error correction mechanism that effectively distributes the eventual transmission path burst errors to single bit reception errors at reception and is capable of correcting all of them on the octet level. This feature is taken advantage of in the specified application layer forward error correction method.

Contention-based, individually addressed messaging between the base station 4 and the receiver stations is used for the configuration, status monitoring, and control of the signal transmitters as well as the signal source equipment attached to them. There is an infrared handheld remote controller receiver, a USB 2.0 computer communication receiver/transmitter and a USB 2.0 general-purpose receiver/transmitter for Bluetooth and WLAN handheld remote controller adapters in the collector receiver station 3.

### System Configuration, Monitoring, and Control

The system configuration, monitoring and control are done from the handheld remote controller(s) or from a (personal) computer application(s) as described above.

### Source Transmitters

According to FIG. 4 the receiver 6 typically consists of a MIMO antenna subsystem 172, the IEEE 802g conformant WLAN circuit with the Atheros or Airgo range and transfer rate extensions. There are typically software controlled multi-color LEDs to aid the recognition and status of the individual signal sources 7 for the configuration, status monitoring and control operations. The WLAN is operated at the nominal speed of 108 Mbit/s. The received audio data stream is buffered into a 48 KB input ring or FIFO memory buffer and the source signal transmission from the buffer is started using a hardware timer controlled by the CF-End end-of-frame interrupts and the driver firmware. The data of the different sources is combined by a 32-bit processor 149 and fed to a S/PIDIF and AES3 parallel-to-serial converter 150 followed by optical and coaxial cable driver electronics and corresponding connectors. The output channel mode selection is done by the configuration and control software over the contention communication service of the WLAN.

The source transmitters 6 of the up to 16 channels each have an internal crystal-derived clock to generate the 192,000 Samples/s clock. These clocks are restarted by the end-of-frame interrupt generated by the CF-End control message of each of the 6,144 μs transmission slot to keep the independent signal sources and their sampling operations accurately mutually synchronized.

### Remote Control Terminals

Two methods exist for the control of the system, a battery-powered handheld control terminal 5 and a software application available for several platforms including Linux, MS Windows, Apple, and Symbian operating systems.

### Handheld Remote Controller

The handheld remote controller 5 contains a keypad, a small display, a processor and a communication link to the base station. The keypad functions allow the selection of the output ports 2, the signal source group 8 and individual signal source 7 configuration and control. Signal source groups 8 as well as individual sources 7 can be smoothly activated and deactivated and their programmable features can be remotely adjusted. The handheld remote controller communicates with the collector receiver station 4 via an infrared, Bluetooth or WLAN link. The receiver station 4 relays the controls to signal sources through the individual signal transmitters using contention mode communication and either group or individual addressing. There is a panic key and function in the remote controller 5 that causes the smooth immediate muting of all signal sources 7.

### Remote Control Software

The system described above can be fully controlled by a computer running the configuration, monitoring, and control application software. The commands and responses are communicated with the transmitter base station using a Bluetooth, IrDA, LAN, WLAN, or USB link.

### Method

According to FIGS. 5 and 6 the invented apparatus transmits isochronously, in real time, up to 16 fully independent but synchronized, strongly encrypted and uncompressed channels of 24-bit 192 000 Sample/s digital audio streams 11 from the individual signal sources to a common collector receiver station. A group 10 of 688 (or exceptional 689) discrete 24-bit samples 11, totalling 2 064 (or 2 067) sample octets, will be called transmission level source data block format in the rest of this presentation. The sustained application level digital audio data bandwidth requirement is thus 73,728 Mbit/s. Additionally there are the overheads caused by the PHY and MAC framing, encapsulation with the Advanced Encryption Standard based CCMP encryption, and the effects of the IEEE 802.11 contention traffic time allocation. These make even the largest IEEE 802.11g WLAN bit rate of 54 Mbit/s insufficient for this application. With today's standard WLAN techniques, the required performance cannot be achieved. The novel transmission method described below is based on the innovative use of the contention-free speeded-up unicast transmission with the Point Coordination Function (PCF) as specified in the IEEE 802.11 standards. With careful parameter tuning the bandwidth of the WLAN can be optimally divided between the PCF contention-free medium access mode and the usual Decentralized Control Function (DCF) contention access mode so that the isochronous multi-channel digital audio transfer becomes possible. With the 108 Mbit/s extension of the IEEE 802.11g WLAN network and by using the ERP-OFDM PHY layer framing it is possible to transmit the aimed sixteen (16) independent 24-bit, 192 kSample/s digital audio streams isochronously together with normal contention based WLAN data traffic. The same is, of course, also possible with the highest bit rates of the IEEE 802.11n equal or higher than 108 Mbit/s. The high number of channels, the high resolution, and the high sampling rate guarantee the wireless collection of the best sound quality commercially available today.

### Data Structure

According to FIG. 25 the aim of the invention is to transfer enough audio blocks (transmission level audio data format) 10 in order to collect high quality audio sound. Firstly, the beacon interval 137 defined by the software settings has to be chosen correctly in order to achieve the aim. The beacon signal, defining the length of the beacon interval 137, is sent in intervals defined by an integer in the IEEE 802.11g WLAN standard. The value of this integer may have values from 1 to N. In other words, beacon interval 137 is a product of the beacon integer and time unit (TU). The length of one TU in IEEE 802.11g WLAN standard is 1,024 μs and therefore the beacon interval 137 is a multiple of TUs (1,024 μs). However, the standard defines, that in each beacon interval 137 there should be enough time reserved for the contention traffic, more precisely enough time for a maximum size frame, ACK, 2 slot times and 2 SIFS. In accordance with the invention, an optimum value for the number of time units TU for a beacon interval 137 is found to be 7. The optimum amount can be defined also as a sufficient amount in one preferred embodiment of the invention. This gives enough time to send 32 audio MAC frames 174 within one beacon interval 137. Each audio MAC frame 174 includes 688 or 689 transmission level audio data format blocks 10, the number of these blocks is defined in accordance with the table of FIG. 23. In this figure one row represents the content of the audio MAC frames 174 in one contention free period 138 of a beacon interval 137. As can be seen from FIG. 23, a predetermined sequence is repeated after each 125 beacon intervals. With the help of this detailed sequence, the average flow rates of the audio sources and WLAN output are matched, and the jitter can be held at the minimum, as shown in FIG. 24. This also results in a minimum requirement of buffer memory both in the transmitter and in the receivers 6.

### Bandwidth Division

According to FIG. 25, in order to guarantee the timely transport of audio source data, the highest possible repetition rate of contention-free periods 138 must be realized. At the same time, the maximum fraction of the network capacity must be reserved for the audio traffic. The IEEE 802.11 standard requires that there must be enough contention traffic time within each repeating contention-free interval for the transmission of one maximum size data frame together with its acknowledgement frame plus two SIFS periods and two slot times. With the 108 Mbit/s bit rate and with the ERP-OFDM PHY framing this requirement equals to 212+40+2×10+2×9=290 μs. As described in the IEEE 802.11 standard, the contention traffic in the beginning if the contention free period 138 may foreshorten the contention period by a maximum value of the sum of an RTS control frame, a CTS control frame, one maximum size data frame, an ACK control frame plus four SIFS. With the 108 Mbit/s bit rate and with the ERP-OFDM PHY framing this requirement is equal to 40+40+212+40+4×10=372 μs. The contention-free period starts with a Beacon frame 67 (FIG. 13) followed by a SIFS. With the 108 Mbit/s bit rate and with the ERP-OFDM PHY framing this requirement equals 76+10=86 μs. The contention-free period ends with a CF-End frame 109 (FIG. 20). With the 108 Mbit/s bit rate and with the ERP-OFDM PHY framing this requirement equals to 40 μs. The remaining time within the contention-free repetition interval is available for the contention-free data traffic. As the granularity of the contention-free interval is one 1,024 μs time unit (TU), the time available for contention-free traffic when the contention free interval is set to one TU is 1024−290−372−86−40=236 μs. Taking into consideration the maximum data frame size as specified by IEEE 802.11, the MAC, CCMP, and PHY encapsulation overheads and the SIFS between successive data frames, only the maximum of 17.7 Mbit/s effective user data speed can be done with this interval set-up. With contention free interval set to seven (7) TUs, the time available for contention-free data becomes 6 352 μs which allows the transmission of up to 32 of the 688 (or 689) sample blocks of 24 bits each. With 32 blocks per interval each of the 16 data sources will transmit a sample data block twice. This arrangement minimizes the sampling rate and transmission rate alignment cycle and simplifies the alignment algorithm.

To optimize the smooth flow of data and to minimize the buffering needs, the average rate of samples per TU should be kept as close to 1,024/1,000×192=196.61 as possible by varying the size of the data frames in the proper way in accordance with FIG. 23. At the same time the data flow from each of the 16 data sources should be as smooth as possible. The following frame size algorithm, that is one of the key innovations in this invention, is introduced. The contention-free time is first split into 32 block buffers of varying size. Each buffer corresponds to an individual sequential signal source. During each contention-free period each of the 16 sources transmits twice making the total of 32 buffers. These buffers are presented as columns in FIG. 23. The buffer size varies between 688 and 689 sample records each, according to the following set of size adjustment rules. If no exception rule applies, the default size is 688. The exceptional blocks contain 689 sample records each. The first exceptional block number xⱼ₁ for the j-th data source is calculated by the formula

x_{j,1}=8 mod (13−j)+1,

resulting values 5, 4, 3, 2, 1, 8, 7, 6, 5, 4, 3, 2, 1, 8, 7, and 6 for the signal sources from 1 to 16, respectively. After this an exceptional data blocks repeats after each seven default size blocks until the limit of 250 source blocks is reached. Yet another exception rule is applied. For sources 1, 2, 3, 6, 7, 8, 9, 10, 11, 14, 15, and 16 the blocks 200, 221, 242, 11, 32, 53, 74, 95, 116, 137, 158, and 179 each will contain 689 sample records. After 250 blocks the full cycle is repeated. The full cycle thus contains 125 intervals of 7 TUs each resulting a full cycle time of 125×7×1 024 μs=896 ms. Each independent signal source transmitter implements its own sequencing. This algorithm guarantees, in accordance with FIG. 24, that the buffering jitter remains below +/−1.5 sample within all the buffer sets and becomes zero at the end of each 125^{th} sample buffer set. With this adjustment algorithm there is a worst-case margin of 80 μs within the contention-free data transfer time. This arrangement also makes it possible to support the effective user data contention traffic of up to 5 Mbit/s along with the real-time audio transmission. The contention traffic is available for system configuration and control as well as for other independent data exchange.

As shown above, the choice of at least seven TUs for the duration of the Beacon Repetition interval is required to reserve enough bandwidth for the contention-free isochronous audio traffic and to keep the rates alignment algorithm manageable. Selecting the minimum value of seven TUs further minimizes the system delay and buffering requirements. Also, selecting the value of seven TUs instead of any bigger ones, creates a maximum bandwidth for the contention-based traffic, in addition to the contention-free isochronous audio traffic.

### Error Control

According to FIGS. 6 and 7, the error control method is optimised for simplicity and speed under the assumptions of human listening of multi-channel studio-quality voice and music audio sound. This means a simple and fast best-effort error correction scheme that reduces the audible effect of the errors to a non-observable level. The method takes advantage on the long 24-bit audio data samples and the high 192 kSample/s sampling rate as well as the inherent property of the extended IEEE 802.11g implementation to transform transmission path originated burst errors to single-bit errors in reception. However, this error correction scheme is not appropriate for applications where no errors can be tolerated.

Thanks to the WLAN transmission error correction method, almost all the residual reception errors are single-bit errors. It is therefore sufficient to correct the effects of single bit errors. The error detection is done by comparing a sample to the average of the immediately preceding and following samples. If the difference is larger than a predefined maximum inter sample difference limit then all the 24 one bit variants of the sample prepared by bitwise exclusive or function of all the bit locations are compared to the calculated average and the one with the smallest absolute difference is chosen to replace the erroneously received sample. This process is illustrated in FIG. 7. Because of the high sampling rate, the residual errors are not audible by the human ear.

### Synchronization

According to FIG. 20, the synchronization within the system is based on the repetitive appearance of the end-of-frame interrupt generated by the CF-End frame 109 at exactly 6 802 μs after the beginning of each repeating 7 168 μs contention-free repetition interval. The end-of-frame interrupt of this control message 109 synchronizes all the signal transmitters 6 in regard of signal sampling, transmission block size calculation, and transmission timing within the inaccuracy of the interrupt latency time difference of the receivers. Because all the receivers are programmed to wait for this particular interrupt, the system level synchronization jitter caused by the interrupt latency is of the order of one instruction execution cycle (added with the very small processor-to-processor crystal oscillator phase jitter). In practise, this total jitter is of the order of 100 ns and cannot possibly be noticed by human listener. For comparison, the 192 kSample/s audio sampling cycle is 5.21 μs.

### Detailed Description of the WLAN Transmission Cycle

According to FIG. 25 in the idle state, when no audio signal is present, the collector receiver is programmed to run the beacon interval of one time unit (1 TU). When the audio stream needs to be started, a contention-free mode command is sent to all transmitters using their group address and the beacon interval is reprogrammed to 7 TUs of 1 024 μs each totalling 7 168 μs. The CF-End end-of-frame interrupt of this frame triggers the beginning of synchronous source signal sampling in all transmitters. The transmitters also program their hardware transmitter timers to be started by the same interrupt. The transmission start time for each signal source is determined by the timer value generated by a special virtual token passing method as follows. The point coordination function (PCF) is implemented in the receiver collector of the WLAN access point station. The beacon repetition interval, and hence the contention-free repetition interval, are set to seven time units and every such period contains a contention-free and a contention part. The length of the allocated contention-free period is set to 6 748 μs using the CFPMaxDuration parameter in the Beacon frame 67 and this set-up leaves a guaranteed 290 μs for the decentralized control function (DCF) contention traffic. This time is large enough for the transmission one maximum length data frame during the contention period together with its acknowledgement and the associated inter-frame elements as required by the IEEE 802.11 standard. It also means that a minimum of 2.58 Mbit/s of bandwidth (when maximum size data frames are used) is always available for contention traffic. Under heavy traffic of large frames, the allocated contention-free period becomes foreshortened from the beginning when a frame is being transmitted during the expected start of the contention-free period. Because this contention exchange can include the CTS and ACK control frames with their associated inter-frame elements in addition to a maximum size data frame, up to a maximum of 324 μs may be consumed by the busy medium from the beginning of the contention-free period.

The worst-case transmission-timing scenario for the audio data is as follows. The expected beginning of the contention period occurs but a maximum length contention transfer sequence was just started. It will cause a 324 μs contention-free period foreshortening. Only after this foreshortening delay, the 40 μs Beacon message that sets the NAV condition, can be transmitted. The first audio data block transmission starts after an additional 10 μs SIFS time has elapsed. This is a total of 374 μs after the expected beginning of the contention-free period. In the case of a smaller or none foreshortening, a quiet filler period is inserted by the transmitter software to reach the 374 μs tick. This arrangement guarantees that the first audio bit is always sent on the same relative tick within the 6 748 μs contention-free repetition interval. The available transfer time for the contention-free audio data is therefore 7 168−374−290−40−10=6454 μs. In the worst-case scenario, all audio buffers contain either 688 or 688 24+8-bit sample records. The time needed to physically send either buffer together with their MAC headers and trailers as well as an AES based CCMP encapsulation overheads is the same 186 μs. Each frame is followed by a 10 μs SIFS period. The time needed to send two full sets of sixteen blocks from the sixteen independent signal sources together with their SIFS periods is thus 2×16 (186 +10)=6 272 μs. The transmission sequence is finally followed by a 80 μs programmed idle delay after which a 40 μs CF-End broadcast frame 109 terminates the contention-free period, also resetting the NAV condition initially set by the beginning of the Beacon frame. This happens exactly at the same time as the contention-free period would have ended based on the timers set by the CFPMaxDuration parameter of the Beacon frame. The time margin within the contention-free period of 80 μs out of the minimum available time of 6 352 μs represents just a 1.26 percent contention-free time margin. At this point, the contention period starts allowing the transmission of a single maximum size frame with an ACK response plus the associated two inter-frame SIFS times and two slot times as specified in IEEE 802.11 standard.

### Operation of the Transmitter and Base Station

In accordance with FIGS. 1 -3 based on the commands from the remote controllers 5 the system selects a recording or broadcasting subset out of the possible n AES (S/PDIF) digital outputs. The roles of the signal sources 6 are also programmed at this point with the controllers using the individual addresses of the signal sources 6 and their LED indicators. Also the group address of the signal sources is set now.

In this application the speeded-up multicast means a procedure, where all transmitters 7 transmit their data packages back-to-back using the same group address and the end of frame interrupts triggered hardware timers for their transmission timing. Thus no polling and no acknowledgements are used. The first transmitter 7 is programmed to transmit 10 μs after the end of the end of frame interrupt of the Beacon frame. Other transmitters 7 are programmed to transmit 10 μs after the end of the end of frame interrupt of their predecessor's frame. Transmitter number 16 is considered the predecessor of transmitter 1. The sequence ends when each source transmitter has transmitted twice. The transmission times are listed in FIG. 25a and illustrated in FIG. 25b. This protocol is called the simplified Virtual Token Passing (sVTP).

This invention is applicable for various isochronous data transmission systems, but as described here, it is particularly suitable for multi channel audio signal collection purposes.

Some video applications are also suitable for some embodiments of the present invention.

In addition to the WLAN transmission medium, this invention is also applicable for UltraWideband radio transmission technology, or HomePlug AV type transmission technology, where the mains power cable is used also for data transmission. In the latter case, the transmission system is not literally wire free, but since active loudspeakers always require external power feeding through a cable, no additional cabling is required for data transmission.

1. An isochronous signal collection method for streaming digital isochronous data from multiple, independent but coordinated, signal sources in a standard wireless local area network transmission system where bandwidth is reserved for both contention-based traffic and contention free traffic, the method comprising the steps of;
organizing audio data formed by samples in audio frames and sending the audio frames to a receiver using speeded-up multicasting, within consecutive beacon intervals, and
adjusting the contention free traffic of the beacon interval to an optimum value such that,
enough bandwidth is reserved for the contention-free isochronous audio traffic,
the system delay and buffering requirements are minimized, and
a maximum bandwidth for the contention-based traffic is reserved, in addition to the contention-free isochronous audio traffic.

2. A method in accordance with claim 1 further comprising the step of,
setting the IEEE 802.11 standard for the beacon interval to 7 time units.

3. A method in accordance with claim 1 further comprising the step of,
varying the number of the samples in the audio frames in order to minimize the buffer size in the transmitter and receivers.

4. A method in accordance with claim 3 further comprising the step of,
varying the number of samples in the audio frames in a cycle of 125 consecutive beacon intervals.

5. A method in accordance with claim 4 further comprising the step of,
varying the number of samples in the audio frames in a cycle of 125 consecutive beacon intervals in accordance with a set of rules

6. An isochronous transmission method for collecting streaming multi channel digital isochronous data from multiple independent sources in a standard wireless local area network transmission system, where bandwidth is reserved for both contention-based traffic and contention free traffic, the method comprising the steps of;
organizing audio data formed by samples is organized in to audio frames and sending the audio frames to a receiver using speeded-up multicasting, within consecutive beacon intervals,
adjusting the contention free traffic of the beacon interval to an optimum value, and
adjusting the length of the beacon interval such that a required amount of audio data can be sent to the receivers with minimum system delay.

7. A wireless transmission system for collecting streaming digital serial audio data, in which system bandwidth is reserved for both contention traffic and contention free traffic, the system comprising;
an organizing means for organizing the audio data formed by samples in audio data frames and control frames,
a sending means for sending the frames to the receiver within consecutive beacon intervals, and
an adjusting means for adjusting the contention free traffic of the beacon interval to an optimum value such that,
enough bandwidth is reserved for the contention-free isochronous audio traffic,
the system delay and buffering requirements are minimized, and
a maximum bandwidth for the contention-based traffic is reserved, in addition to the contention-free isochronous audio traffic.

8. A system in accordance with claim 7, further comprising,
a setting means for setting in IEEE 802.11 standard the beacon interval to 7 time units.

9. A system in accordance with claim 7, further comprising;
a varying means for varying the number of the samples in the audio frames in order to have a smooth data flow with minimal jitter and to minimize the buffer size in transmitter and receivers.

10. A system in accordance with claim 9, wherein the varying means varies the number of samples in the audio frames in a cycle of 125 consecutive beacon intervals.

11. A system in accordance with claim 10, wherein the varying means varies the number of samples in the audio frames in a cycle of 125 consecutive beacon intervals in accordance with a set of rules.

12. A wireless transmission system for streaming digital serial audio data, in which system bandwidth is reserved to both contention traffic and contention free traffic, the system comprising;
an organizing means for organizing the audio data formed by samples in audio data frames and control frames,
a sending means for sending the audio data frames and control frames to a receiver within consecutive beacon intervals,
a first adjusting means for adjusting the contention free traffic of the beacon interval to an optimum value, and
a second adjusting means for adjusting the length of the beacon interval such that a required amount of audio data can be sent to the receiver with minimum system delay.

13. A method in accordance with claim 1, the method further comprising the steps of;
dividing the audio data into data blocks of a predetermined length, and wherein when a difference between an audio data sample and the average of the preceding and following samples exceeds a predetermined limit, replacing the corresponding audio data by the nearest one bit exclusive or function variant of the received data compared to this average.

14. (canceled)

15. (canceled)

16. (canceled)

17. (canceled)

18. A method in accordance with claim 1, in which the method further comprises the steps of;
organizing the audio data in frames containing control frames and audio frames,
sending the organized audio data is sent by multicasting to multiple receivers within consecutive beacon intervals from multiple transmitters, and
synchronizing the audio data between the multiple transmitters by an interrupt signal generated by each beacon interval.

19. (canceled)

20. A method in accordance with claim 18, wherein the interrupt command is an end of frame interrupt command.

21. (canceled)

22. (canceled)
